(19) United States
(12) Patent Application Publication
(10) Pub. No.: US 2014/0279856 A1
(43) Pub. Date: Sep. 18, 2014

(54) METHODS AND APPARATUS TO UPDATE A REFERENCE DATABASE

(71) Applicants: Venugopal Srinivasan, Tarpon Springs, FL (US); Alexander Topchy, New Port Richey, FL (US); Raghuram Ranganathan, Tampa, FL (US)

(72) Inventors: Venugopal Srinivasan, Tarpon Springs, FL (US); Alexander Topchy, New Port Richey, FL (US); Raghuram Ranganathan, Tampa, FL (US)

(21) Appl. No.: 13/839,722

(22) Filed: Mar. 15, 2013

(51) Int. Cl. G06F 17/30

(52) U.S. Cl. CPC G06F 17/30345
USPC 707/609

(57) ABSTRACT

Methods and apparatus are disclosed for updating an index of a reference data database. An example method includes, in response to receiving reference data at a reference database, inserting the reference data in a first portion of the reference database, updating a first portion of an index corresponding to the first portion of the reference database; and updating a second portion of the reference database by shifting the reference data from the first portion of the reference database to the second portion of the reference database, and after shifting, recomputing a second portion of an index corresponding to the second portion of the reference database.

### FIELD OF THE DISCLOSURE

This disclosure relates generally to a database index, and, more particularly, to updating a database index.

### BACKGROUND

Databases are often used to store and organize data. A database index may be used to identify a location of data within a database. For example, a database index may include a list of data from a field in the database sorted so that a particular entry in that field can be quickly located. The data may be linked (e.g., stored in another column of the index) to a location in the database (e.g., a key field, an address, etc.) so that the corresponding entry in the database can be located. When data is added to the database, the index is updated to reflect the addition of the data.

Databases may be used to store reference data, such as media identification data (e.g., audio fingerprints, metadata, signatures, codes, watermarks, etc.). Media identification data is any information that is tracked to identify media exposed to an audience. Media identification data may be generated through analysis of an audio stream. Audio fingerprints may be generated by processing a spectrum of short segments of an audio stream. For example, a 24 bit integer representative of a block of audio may be computed as an audio fingerprint. Fingerprints may not be unique (e.g., the same fingerprint may be calculated for different media). Accordingly, a sequence of fingerprints may be used to uniquely identify media. To identify media, a calculated fingerprint or sequence of fingerprints may be compared with a reference fingerprints in a reference database (e.g., a database of fingerprints generated from known data prior to or at the same time media is broadcast). When a fingerprint is matched to a reference fingerprint in the reference database, a sequence of fingerprints in a “neighborhood” surrounding the reference fingerprint in the database may be compared to a fingerprint sequence generated for the media to uniquely identify the media.

### BRIEF DESCRIPTION OF THE DRAWINGS

FIG. 1 illustrates a prior art index data structure including a reference data array, a count array, and an inverted index array.

FIG. 2 is an example reference database index constructed in accordance with the teachings of this disclosure.

FIG. 3 is a block diagram of a data identification system including an example reference index updater constructed in accordance with the teachings of this disclosure.

FIG. 4 is a block diagram of an example reference index updater that may be used to implement the reference index updater of FIG. 3.

FIG. 5 is a block diagram of an example index generator that may be used to implement the reference index updater of FIGS. 3 and/or 4.

FIG. 6 is a flowchart representative of example machine readable instructions that may be executed to implement the example reference index updater of FIGS. 3 and/or 4.

FIG. 7 is an example diagram of a shift method that may be implemented by the example count array and the example inverted index of FIG. 4.

FIG. 8 is a block diagram of an example processor platform which may execute the instructions of FIG. 6 to implement the example apparatus of FIGS. 3, 4 and/or 5.

### DETAILED DESCRIPTION

Methods, apparatus, and articles of manufacture to update one or more reference database indices are disclosed herein. Some example methods include updating a first portion of an inverted index of a reference database at a variable rate (e.g., when a reference sample is received at a reference database), and updating a second portion of the inverted index at a fixed rate. In some examples, updating the inverted index includes clearing the first portion of the inverted index, and re-computing the second portion of the inverted index. Some example methods include updating first and second portions of a count array and first and second portions of an inverted index array of the inverted index. In such examples, first and second portions of the count array include index information corresponding to the first and second portions of the inverted index array, respectively.

In some examples, the reference database stores media identification data, such as signatures, watermarks, fingerprints, codes, etc. In some examples, a first portion of the inverted index stores index information corresponding to reference data associated with a current period of time (e.g., the current day) and/or a most recent time period and the second portion of the inverted index stores index information corresponding to reference data associated with a past period of time (e.g., the previous 8 days). The example reference data may be associated with a time period (e.g., identified by a timestamp) based on when the reference data was created or when the reference data was received in the reference database. In some examples, when the reference data is media identification data, the media identification data is accompanied by media identification information, such as a time period when a program corresponding to the media identification data is to be broadcast or has broadcast (e.g., live programming may be associated with a current time period).

FIG. 1 illustrates several data structures 100 including a reference data array 110, a count array 120, and an inverted index 130. The example reference data array 110 may be stored in a reference database (e.g., a media identification database) and includes a location field 112, a reference data field 114, and an information field 116. The count array 120 and inverted index array 130 may also be stored in the reference database in an index area separate from the reference data array 110 to facilitate the location of data in the reference data array 110. Alternatively, the reference data array 110, the count array 120, and the inverted index array 130 may be stored in the same location in a database or in any other data structure.

The example reference data array 110 includes a location field 112, a reference data field 114, and an information field 116. In the illustrated example, the location field 112 stores an address (e.g., an index, a location, a key, etc.). The reference data field 114 stores the reference data. The example information field 116 of FIG. 1 stores timestamp information (e.g., a time (e.g., 12:04:08) and a date (e.g., Jan. 28, 2013)). In some examples, other information (e.g., source identifier, etc.) may alternatively or additionally be included in the information field 116.

The reference data array 110 of FIG. 1 includes N₈ entries, where N₈ is a large number (e.g., 43 million). The example reference data array 110 stores reference data received over a certain period of time (e.g., over the past nine days). The reference data 114 may be organized based on time (e.g., by including a timestamp in the information field 116), reference data value (e.g., integer value), etc. In some examples, the reference data 114 is unorganized, and/or newly received reference data is added to the end of the reference data array 110. The reference data 114 is stored at an address location 112 (e.g., (j), (k), (m)) of the reference data array 110.

The example count array 120 of FIG. 1 includes a count sort field 122 and a count value field 124. The count sort field 122 is sorted (e.g., in ascending or descending order) based on possible reference data values (e.g., 0-16777215) of the reference data in the reference data field 114. The count value field 124 stores count indicators corresponding to the value in the count sort 122 for identifying the number of occurrences of each value (e.g., 0-16777215) of the reference data 114 in the reference data array 110.

The inverted index array 130 of FIG. 1 includes an index sort field 132 and a storage location field 134. The index sort 132 is sorted (e.g., in ascending order or descending order) by the count value 124 (from the count array 120). The location field 134 stores location information corresponding to the location (e.g., (j), (k), (m)) in the reference data array 110 of the reference data 114 associated with the count value 124.

In the illustrated example of FIG. 1, a reference data value 10001 is located at both index (j) and index (k) and a second reference data value 10002 is located at index (m). The example count array 120 and the example inverted index array 130 of FIG. 1 are computed when new reference data is received and/or added to the reference array 110. In the example of FIG. 1, reference data with data value 10001 was recently received and stored at index (k). Upon receipt of this new reference data at index (k), the count values 124 are recomputed. In this example, the count value 124 for the value 10002 of the count sort 122 has increased from 8751 to 8752 (i.e., one new sample with data value 10001 was added). A count of the number of occurrences of reference data having the value 10001 may thus be computed as the difference between C[10002]-C[10001]. The inverted index array 130 is then computed by identifying a range of values q (e.g., 8750, 8751) for the inverted index sort 132 determined by the count array 120 where C[10001]≦q<C[10002] (i.e., 8750≦8750, 8751<8752), and q provides the number locations 112 storing reference data having the newly received reference data value. Additionally, the storage indices (j), (k), (m) of the reference data 114 are retrieved and assigned to locations 134 corresponding to the inverted index sort 132 (e.g., 8750, 8751, 8752).

In the example of FIG. 1, when query data of a query sequence having the data value 10001 is received, the index locations 112 of the reference data array 110 that include the data value 10001 are determined from the count array 120 and the inverted index 130. As shown in FIG. 1, to determine the number of locations 114 having data with a value that matches the value 10001, the difference between the counts is calculated C[value+1]-C[value] (e.g., C[10002]-C[10001]). Thus, in the example of FIG. 1, the count array 120 identifies that data with the data value 10001 is located at two locations (8752−8750=2) in the inverted index array 130.

The inverted index array 130 is referenced to identify the location 112 of the two reference data occurrences having the value 10001 in the reference data array 110 based on the identified count value 8750 of the data value 10001. As shown in FIG. 1, the inverted index array 130 is sorted by the count value 124 of the count array 120 (e.g., 8750, 8751, etc.). Identifying the count value 8750 of the data value 10001 and referencing the number (n) of occurrences (2, in this example) identified from the count array 120, provides the locations (j) and (k) from the count values 8750 and 8751 (Cₙ₋₁[value] for n occurrences yields: C₀[10001]=8750, C₁[10001]=8751). Therefore, the inverted index array 130 identifies that data with the data value 10001 is located at the indices (j) and (k) in the reference data array 110.

In some examples, after the location(s) 112 of the reference data array 110 having the data value that matches the query data value is/are determined, a process to match a query sequence including the query data value to a reference sequence may be performed. The process to match the query sequence to the reference data in the reference data array 110 may comprise comparing the query data of the query sequence to reference data in locations surrounding the identified location(s) 112 (e.g., (j), (k)). For example, a first reference sequence is identified and formed from the reference data at the index (j) and the reference data in locations neighboring the index (j), and a second reference sequence is identified and formed from the reference data at the index (k) and the reference data in locations neighboring the index (k). The first and second reference sequences are compared to the query sequence. If the query sequence matches the first reference data sequence, then information (e.g., source data, time information, etc.) corresponding to the data (e.g., the data at index (j) having a value 10001) at identified location(s) 112 and surrounding indices may be retrieved and associated with the query sequence data. For example, if a query sequence including an audio fingerprint from a media presentation is matched to a reference audio fingerprint, a determination can be made that media associated with the reference audio fingerprint was presented, for example, at a certain time, location, channel, etc. stored in the information field 116 corresponding to the identified location(s) 112.

The data structures 100 of FIG. 1 identify the location 112 of reference data (having a particular value) in a reference database. A drawback of the data structures 100 is that the inverted index 130 and count array 120 of the data structure 100 of FIG. 1 must be updated each time a reference data sample is received by the reference data array 110. If the count array 120 and the inverted index 130 are not updated after each receipt of a data sample, the counts and index locations will be inaccurate. Considering that, in some examples, millions of reference sequences (e.g., reference sequences including query data having a value 10001) can be received each day, a large number of recalculations for the inverted index 130 and count array 120 may be required. Furthermore, the time it takes to recompute the inverted index 130 and count array 120 (e.g., updating the indices, sorting the data values in the count sort 122, and retrieving index location data for the inverted index 130) is proportional to the number N₈ (e.g., up to 43.2 million) of locations including reference data (e.g., having a bit length of 16-32 bits) in the reference data array 110. In some examples, recomputing the inverted index array 130 and the count array 120 may take up to several seconds (e.g., over six seconds). However, in some examples, matching query data to reference data must be processed in a fraction of that time to keep up with received data.

Both reference sequences and query sequences may be computed as blocks representing a short duration of audio. In an example system, 128 24-bit signatures can be generated from a 2.048 second duration audio clip. In the case of query signatures, two such blocks generated consecutively and representing 4.096 seconds of audio may be required to obtain a reliable match. To identify certain types of media presentations (e.g., live programming) the reference database needs to be updated each time a block of reference signatures is received. In addition to reference signature blocks being received, query blocks may also be received simultaneously or substantially simultaneously. Thus, to match query sequences to live programming audio fingerprint sequences, the reference database needs to be updated in a small fraction of the duration of a signature bock (e.g., 2.048 seconds) leaving adequate time for real time matching of multiple query signature blocks received.

In some media identification examples, reference data, such as media identification data (e.g., an audio fingerprint, digital watermark, signature, code, etc.) is available prior to a broadcast of a program, and therefore the inverted index array 130 and count array 120 of FIG. 1 are precomputed. However, in some examples, especially for programs broadcast “live,” the reference media identification data is not available prior to broadcast, requiring the inverted index array 130 and count array 120 to be updated in real time as the program is broadcast. As described above, frequent updates may be time consuming, cause database server latency, and in some instances render the indices inoperable.

Example methods and apparatus disclosed herein address time and computing issues described above when recomputing the inverted index and count array upon receipt of new reference data samples.

FIG. 2 illustrates an example implementation of a reference data array 210 and a reference index 215 constructed and controlled in accordance with the teachings of this disclosure. The example index 215 includes a count array 220 having a fixed portion 222 and a variable portion 224 and an inverted index array 230 having a fixed portion 232 and a variable portion 234. The example reference data array 210 may be similar to the reference data array 110 of FIG. 1 with reference data 214 and reference data information 216 (e.g., timestamp information, source information, etc.) stored at locations 212. In the illustrated example of FIG. 2, there may be N₈ storage locations 212, wherein N₈ corresponds to the number of reference data values received over an example period of time (e.g., 8 days). In some examples, the reference data array 210 stores all reference data and corresponding reference information of a database. In some examples, the reference data array 210 is a dedicated database for storage of a specific type of reference data (e.g., media identification data associated with live programming and/or programming that was broadcast live).

In the illustrated example of FIG. 2, the variable portion of the count array 224 and the variable portion of the inverted index array 234 correspond to reference data received during a current time period (e.g., the current day), and the fixed portion of the count array 222 and the fixed portion of the inverted index array 232 correspond to data received during a past time period (e.g., the previous seven days before the current day). In some examples, the variable portion of the count array 224 and the variable portion of the inverted index array 234 store index information (e.g., data similar to the count data 122, 124 and/or inverted index data 132, 134 of FIG. 1, etc.) corresponding to media identification data (e.g., audio fingerprints, signatures, watermarks, etc.) stored in the reference data array 210 during the current time period.

For example, in FIG. 2, index information for media identification data corresponding to live programming and/or live broadcasts may be added to the variable portion of the count array 224 and the variable portion of the inverted index array 234 as it is broadcast during a current time period (e.g., a current day). The example fixed portion of the count array 222 and the example fixed portion of the inverted index array 232 store index information corresponding to media identification data received during a previous time period (e.g., 7 days). The media identification data received during the previous seven days may be media identification data that was precomputed or available prior to when a corresponding program was broadcast (e.g., non-live programming), media identification information corresponding to live programming that was broadcast during the previous seven days, etc.

FIG. 3 is a block diagram of an example reference data collection system 300. The example reference data collection system 300 is a media identification system that determines media exposure for audience measurement purposes. Alternatively, the reference data collection system 300 may collect other types of data (e.g., security data) to identify information, a source of information, and/or validity of information by providing query data for comparison with reference data (e.g., determining a match in facial recognition, fingerprint identification, verification of identification, certifications, etc.). The example reference data collection system 300 includes meters 310, a central data facility 320, and a reference data generator 330. The example central data facility 320 includes an example data collector 312, an example reference database 314 including the example index 215 of FIG. 2, an example reference index updater 340, an example query matcher 350, and an example match database 360. The example data collector 312 facilitates communication with the meters 310 and the reference data generator 330.

The example meters 310 of FIG. 3 collect media identification data (audio fingerprints, digital watermarks, signatures, codes, metadata, etc.) associated with media exposed to the meter 310. For example, the meters 310 may monitor audio, video and/or images of a media presentation device and collect media identification information embedded in (or generated based on) the audio, video, and/or images of the media. The meters 310 may collect the media identification data using any desired techniques. For example, the media identification data may be collected by, for example, listening for audio presented within an environment of the meter 310 with a microphone and/or by capturing images of a video presented on the media presentation device via a camera or sensor. In some examples, the meters 310 are one or more of a panelist meter, a device with panelist software (e.g., a mobile phone, personal digital assistant, computer, etc.), etc. The meters 310 then send query data (e.g., data including the media identification information) to the central data facility 320 for processing.

The example reference data generator 330 of FIG. 3 provides the central data facility 320 with reference data for storage in the reference database 314. In the illustrated example of FIG. 3, the reference data generated by the reference data generator is reference media identification data (e.g., audio fingerprints, watermarks, codes, metadata, etc.). In some examples, the reference data may be other data (e.g., database information, identification information, etc.) to be queried (e.g., compared to) for verification and/or identification purposes.

In the illustrated example, the reference media identification data generated by the reference data generator 330 corresponds to media that has been broadcasted, is being broadcasted, or is scheduled to broadcast on a media presentation device (e.g., a television, a radio, a computer, etc.). For example, the reference data generator 330 may be one or more of a media service provider, a media producer, etc. In the illustrated example, the reference data generator 330 appends media identification information for storage in the reference data information field 216 (e.g., a timestamp, source data, etc.) of the reference data array 210. In such examples, the timestamp may indicate at least one of when a media program associated with the media data is to air or has aired and/or when the reference data was generated. The reference data generator 330 may use any desired techniques to generate the reference data.

The example reference database 314 of FIG. 3 stores reference data (e.g., reference media identification data) received from the reference generator 330. The reference database 314 includes the index 215 (e.g., index information of the index 215 is stored in the database 314). The example index 215 is used as described herein to identify the location of a reference media identification data in the reference database 314 to identify media identification information (e.g., source information, channel information, etc.) and further audience measurement information.

In the illustrated example of FIG. 3, the meters 310 send query data sequences to the central facility 320. The example data collector 312 receives the query data sequences and the example query matcher 350 performs a match process to determine whether the query data sequences match reference data sequences in the reference database 314. The query matcher 350 cross-references the reference database 314 using the index 215 (e.g., the count array 220 and the inverted index array 230) to identify a match. As such, the query matcher 350 checks the count array 220 (e.g., the fixed portion 222 and/or the variable portion 224) to determine the number of occurrences of a reference data value that matches a value of the query data sequence. The query matcher 350 then uses the inverted index array 230 to determine the location of the reference data having the matched value. The query matcher 350 then compares surrounding data (e.g., within a “neighborhood” of the matched value locations) in the reference data array 210 to determine whether the query data sequence matches a reference data sequence having the matched value. When the query matcher 350 of FIG. 3 identifies a match between a query data sequence from the meters 310 and the reference data sequence in the reference database 314, a source or identification (e.g., which programs, advertisements, tuned channel number, etc. the meter 310 was exposed to) of the query sequence can be determined. The example query matcher 350 may then store results (e.g., data identifying the source, time, and/or location of media identified by the meters 310) of the match process in the match database 360.

While the query matcher 350 of the illustrated example attempts to match query data to both the fixed portions 222, 232 and the variable portions 224, 234, in some examples, the query matcher 350 checks the variable portions 224, 234 of the index 215 to identify a match, and if the query matcher 350 does not identify a match in the variable portions 224, 234, second check the fixed portions 222, 232 to identify a match. Such a process may allow for faster processing of a query because the variable portions 224, 234 contain less index information than the entire index 215. For example, the query matcher 350 may check the variable portions 224, 234 first when the query data is known, estimated, and/or predicted to correspond to a time period represented in the variable portion 224, 234 (e.g., the query data is labeled as being “live”).

In some examples, the query matcher 350 identifies information 116 (e.g., timestamp information, source information, and/or other similar information) appended to the query data sequences to determine which portions (e.g., the variable portions 224, 234 or the fixed portions 222, 232) of the index 215 to use in identifying the location(s) of matching reference data. For examples, if the query matcher 350 determines that the

The example reference index updater 340 of FIG. 3 monitors the reference database 314 for newly received reference data from the reference data generator 330. In the illustrated example, when reference data is added to the reference database 314, the reference index updater 340 updates the index arrays 220, 230 of the index 215.

The reference index updater 340 of FIG. 3 updates the variable portions 224, 234 of the index arrays 220, 230 each time reference data corresponding to a current time period (e.g., the current day) is added to the reference data array 110 by recomputing the index information for the variable portions 224, 234. The reference index updater 340 updates the variable portion 224 of the count array by re-sorting a count sort of the count array based on the reference data received in the current time period and assigning a count value (similar to the count data 122,124 of FIG. 1, respectively, but only for the variable portion 224). The reference index updater 340 updates the variable portion 234 of the inverted index array 230 by retrieving index location information 212 for the corresponding reference data in the reference data array 210 and storing it with the corresponding count information (e.g., similar to the index data 132, 134 of FIG. 1, but only for the variable portion 234).

The example reference index updater 340 periodically performs a full update of the index 215, including the fixed portions 222, 232 based on at least one of a predetermined time, a length of time since a previous full update, a schedule, etc. The index updater 340 performs a full update by clearing index information from the variable portions 224, 234, removing reference data and corresponding index information associated with an oldest time period (e.g., media identification data corresponding to media presented over 8 days prior to the current day) from reference data array 210 and index 215, respectively, and re-computing the count data and index data for the remaining data in the reference data array (similar to the data structures 100 of FIG. 1, though performed periodically rather than each time reference data is received). As a result of the full update, reference data of the reference data array 210 received during the previous current time period is effectively shifted into the past time period and no longer affects updates to the variable portions 224, 234 of the index 215.

FIG. 4 is a block diagram of an example reference index updater 340 associated with a reference database (e.g., the reference database 314) that may be used to implement the reference index updater 340 of FIG. 3. The example reference index updater 340 includes an example buffer 410, an example index generator 420, an example timer 430, an update controller 440, a database interface 450, and an example input/output 460. The example reference index updater 340 includes an example communication bus 402 that facilitates communication among the buffer 410, the index generator 420, the timer 430, the update controller 440, the database interface 450, and the input/output 460 of the illustrated example.

The example reference index updater 340 of FIG. 4 receives reference data information at the buffer 410 from the server 312. The reference data information (e.g., value, storage location information, timestamp information, etc.) corresponds to reference data received by the server 312 from the reference data generator 330. In some examples, the buffer 410 temporarily holds the reference data information until the update controller 440 determines that the index 215 is to be updated to include the example information. For example, the reference data information may be stored in the buffer 410 because the update controller 440 determines that the index 215 is undergoing an update or is inaccessible (e.g., due to a system failure, due to being in use by another system, etc.).

The example index generator 420 generates an updated index with reference data information from the buffer 410. The index generator 420 of FIG. 4 receives instructions to generate an index from the update controller 440. The example index generator 420 may request the database interface 450 to retrieve reference data and reference data information (e.g., timestamp information of the reference data) from the reference database 314 of FIG. 3 for use in generating updated index arrays (e.g., the count array 220, the inverted index array 230). The index generator 420 of the illustrated example instructs the database interface 450 to store the generated index arrays in the index 215 of the reference database 314. The index generator 420 is further described in connection with FIG. 5 below.

The timer 430 of the illustrated example tracks update timing for the update controller 440. In the illustrated example, the timer indicates when it is time to update the fixed portions 222, 232 of the index arrays 220, 230 of the index 215. In some examples, the fixed portions 222, 232 of the index arrays 220, 230 are updated periodically and/or according to a schedule (e.g., at certain times of the day). In such examples, the timer 430 additionally or alternatively tracks a current time and/or date that may be used to determine when to perform the update to the fixed portions 222, 232.

The example update controller 440 of FIG. 4 triggers the reference index updater 340 to perform an update of the index 215 and controls the type of update to be performed (e.g., a full update of the index 215 and/or an update to variable portions of the index 215). In some examples, the update controller 440 determines that the index 215 is to undergo a full update based on an expiration of a current time period (e.g. the current day indicated by the timer 430). For example, at a predetermined time of a day, such as 12:00 AM EST, the update controller 440 instructs the index generator 420 to perform a full update of the index 215.

The update controller 440 triggers updates to the variable portions 224, 234 of the index 215 based on reference data that is recently added to the reference data array 210 (and/or database 314). In the illustrated example, the update controller 440 determines whether received reference data information 216 (e.g., timestamp information) indicates the reference data is associated with a current time period (e.g., media identification data corresponding to “live” programming and/or programming broadcasted during the current time period) or reference data associated with a past period (e.g., media identification data for programs that broadcast over a previous week). For example, the update controller 440 makes the determination based on a timestamp in the reference data information 216. The example update controller 440 determines when a variable portion of the index 215 is to be updated based on receipt of reference data at the reference database 314 and/or receipt of reference data information at the buffer 410. For example, the variable portions 224, 234 of the index 215 are updated when reference data corresponding to a current time period, such as a media identification data corresponding to a program that is to air or has aired during a current calendar day, is received from the reference data generator 330.

In the illustrated example of FIG. 4, the database interface 450 accesses the reference database 314 and/or the index 215. The update controller 440 uses the example database interface 450 to update data in the reference database 314 and index 215 and/or to retrieve reference data and/or reference data information from the reference database 314 and index information from the index 215.

The example input/output 460 of the reference index updater 340 in FIG. 4 couples the reference index updater 340 to a user interface (e.g., mouse, keyboard, display, touchscreen, etc.). In some examples, a user may select settings (e.g., an update rate of the index 215, an update time of the index 215, etc.) via the user interface and input/output 460. In some examples, the update controller 440 displays settings (e.g., time of full updates, length of the past time period of FIG. 2, etc.) of the reference index updater 340 and/or information from the index 215 to the user via the input/output 460.

While an example manner of implementing the reference index updater 340 of FIG. 3 is illustrated in FIG. 4, one or more of the elements, processes and/or devices illustrated in FIG. 4 may be combined, divided, re-arranged, omitted, eliminated and/or implemented in any other way. Further, the example buffer 410, the example index generator 420, the example timer 430, the example update controller 440, the example database interface 450, the example input/output 460 and/or, more generally, the example reference index updater 340 of FIG. 3 may be implemented by hardware, software, firmware and/or any combination of hardware, software and/or firmware. Thus, for example, any of the example buffer 410, the example index generator 420, the example timer 430, the example update controller 440, the example database interface 450, and the example input/output 460 and/or, more generally, the example reference index updater 340 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example, the example buffer 410, the example index generator 420, the example timer 430, the example update controller 440, the example database interface 450, and/or the example input/output 460 are hereby expressly defined to include a tangible computer readable storage device or storage disc such as a memory, DVD, CD, Blu-ray, etc. storing the software and/or firmware. Further still, the example reference index updater 340 of FIG. 3 may include one or more elements, processes and/or devices in addition to, or instead of, those illustrated in FIG. 4, and/or may include more than one of any or all of the illustrated elements, processes and devices.

FIG. 5 illustrates an example implementation of the index generator 420 of FIG. 4. The example index generator 420 includes an example index controller 510, an example count array generator 520, an example inverted index array generator 530, and an example shifter 540. The example index generator 420 includes an example communication bus 502 that facilitates communication among the index controller 510, the count array generator 520, the inverted index array generator 530, and the shifter 540.

The example index generator 420 of FIG. 5 generates and/or updates the example index 215 illustrated in FIG. 2 based on reference data information (e.g., timestamp information, etc.) and index information (e.g., storage location in the reference data array 210) received via the reference index updater bus 502. The index controller 510 processes the reference data information and determines when to update the count array 220 and the inverted index array 230 of the index 215.

The example index controller 510 of FIG. 5 generates and/or updates the index 215 based on instructions from the update controller 440. Upon receipt of instructions to perform an update to the index 215, the example index controller 510 determines the type of update to the index 215 that is to be performed: a full update of the index 215 or an update to the variable portions 224, 234 of the index 215. Based on the type of update to be performed, the index controller 510 instructs the count array generator 520, the inverted index array generator 530, and/or the index shifter 540 to perform the corresponding update. Accordingly, the index controller 510 determines when index information is to be generated for the count array 220 and the inverted index array 230 and which portion(s) is/are to be updated.

The example count array generator 520 generates and/or updates the count array 220 of FIG. 3 according to instructions from the index controller 510 as described herein. Accordingly, upon receiving instructions from the index controller 510, the count array generator 520 identifies the number of occurrences of reference data values (e.g., by generating a histogram) in the reference data array 210, similar to the count array 120 of FIG. 1. However, the example count array generator 520 recomputes the fixed portion 222 of the count array 220 periodically (e.g., once a day, when a full update of the index 215 is performed) and recomputes the variable portion 224 when reference data is added to the reference database 314 and/or reference data array 210. Accordingly, the count array generator 520 updates the two portions 222, 224 at different rates.

The example inverted index array generator 530 generates and/or updates the count array 230 of FIG. 3 according to instructions from the index controller 510 and/or update controller 440, as described herein. Accordingly, upon receiving instructions from the index controller 510, the inverted index array generator 530 recomputes the inverted index array 230 by retrieving location information of the reference data from the reference data array 210 and assigning the information to the count values generated in the count array 220 similar to the inverted index array 130 of FIG. 1. However, the example inverted index array generator 530 of FIG. 5 updates the fixed portion 232 of the inverted index array 230 at a fixed rate (e.g., once a day, when a full update of the index 215 is performed) and the variable portion 234 at a variable rate (e.g., each time reference data is added to the reference database).

In the illustrated example of FIG. 5, the count array generator 520 and the inverted index array generator 530 cooperatively generate and/or update the count array 220 and inverted index array 230, respectively. Accordingly, when the count array generator 520 updates the count array 220, the inverted index array generator correspondingly updates the inverted index array 230 and vice versa.

The example shifter 540 of FIG. 5 is implemented to perform a full update to the index 215. In the illustrated example, a full update is performed periodically (e.g., once per day, twice per day, etc.). Accordingly, at the end of a current time period, the example shifter 540 shifts reference data from a current time period into a past time period by no longer using the reference data to recompute the variable portions 224, 234 of the index 215. Because the reference data is no longer associated with a current time period, the reference data has effectively been shifted to be associated with a past time period.

Upon receiving instructions from the index controller 510 to perform a full update to the index 215, the shifter 540 of FIG. 5 clears the variable portions 224, 234 of the index 215. The shifter 540 then erases reference data 214 corresponding to an oldest period of time (e.g., media identification data corresponding to programs that broadcast over seven days ago) from the reference data array 210. The index controller 510 then instructs the count array generator 520 and the inverted index array generator to recompute index information to be stored in the fixed portions 222, 232 of the index 215. Accordingly, the fixed portion 232 of the inverted index array 230 may include index information (e.g., storage location information of the reference data from the former current period) associated with reference data that was previously in the variable portion 234, though the fixed portion 232 is recomputed with all reference data 214 stored in the reference data array 210. Accordingly, by removing reference data associated with an oldest time period (e.g., reference data received over 7 days prior to the current day) exceeding a maximum capacity of the reference data database 314 and/or index 215. Furthermore, shifting the reference data associated with a former current time period to the past time period allows for a reset of the variable portions 224, 234 to prevent the amount of index information to become very large, and thus, prevent the length of time to recompute the variable portions 224, 234 from getting very long.

While an example manner of implementing the index generator 420 of FIG. 4 is illustrated in FIG. 5, one or more of the elements, processes and/or devices illustrated in FIG. 5 may be combined, divided, re-arranged, omitted, eliminated and/or implemented in any other way. Further, the example index controller 510, the example count array generator 520, the example inverted index array generator 530, the example shifter 540, and/or, more generally, the example index generator 420 of FIG. 4 may be implemented by hardware, software, firmware and/or any combination of hardware, software and/or firmware. Thus, for example, any of the example the example index controller 510, the example count array generator 520, the example inverted index array generator 530, the example shifter 540, and/or, more generally, the example index generator 420 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example, the example index controller 510, the example count array generator 520, the example inverted index array generator 530, and/or the example shifter 540 are hereby expressly defined to include a tangible computer readable storage device or storage disc such as a memory, DVD, CD, Blu-ray, etc. storing the software and/or firmware. Further still, the example index generator 420 of FIG. 4 may include one or more elements, processes and/or devices in addition to, or instead of, those illustrated in FIG. 5, and/or may include more than one of any or all of the illustrated elements, processes and devices.

A flowchart representative of example machine readable instructions for implementing the reference index updater 340 of FIG. 3 and/or the index generator 420 of FIG. 4 is shown in FIG. 6. In this example, the machine readable instructions comprise a program for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 6, many other methods of implementing the example reference index updater 340 and/or the index generator 420 may alternatively be used. For example, the order of execution of the blocks may be changed, and/or some of the blocks described may be changed, eliminated, or combined.

As mentioned above, the example process(es) of FIG. 6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIG. 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

A program 600 that may be executed to implement the reference index updater 340 of FIGS. 3 and/or 4 is represented by the flowchart shown in FIG. 6. At block 610, the update controller 440 of FIG. 4 determines whether a full update of the index 215 is to be performed. In the illustrated example, a full update of the index 215 is performed periodically. In other words, the update controller 340 performs a full update of the index 215 once during a threshold period of time (e.g., a day, 12 hours, etc.). Alternatively, a full update of the index 215 may be performed upon a user request. The example update controller 440 makes the determination based on information from the timer 430. For example, the timer 430 may track a period of time that has passed since a recent full update of the index 215. When the timer 430 indicates that a threshold period of time (e.g., 12 hours, 24 hours, etc.) has passed, the update controller 440 determines that a full update to the index 215 is to be performed. In another example, the timer 430 may keep track of the current time and/or date. In such an example, the update controller 440 performs a full update to the index 215 at or near a predetermined time of day (e.g., based on settings input via the input/output 460, based on default settings, etc.). At block 610, if the update controller 440 determines that a full update of the index 215 is not to be performed, control advances to block 620. At block 610, if the controller 340 determines that a full update of the index is to be performed, control advances to block 670.

At block 620 of FIG. 6, the update controller 440 determines whether reference data has been received at the central data facility 310 of FIG. 3. In some examples, the reference data is media identification data (e.g. audio fingerprints, watermarks, signatures, metadata, etc.) corresponding to live programming. If the update controller 440 determines that no new reference data has been received, control returns to block 610. At block 620, if the update controller 440 determines that reference data has recently been received, control advances to block 630.

At block 630, the update controller 440 retrieves reference data values 214 and storage location information 212 from the reference database 314 for use in generating index information for the index 215. At block 640, the index generator 420 recomputes the variable portion 224 of the count array 220 and the variable portion 234 of the inverted index array 230 using reference data corresponding to a current time period (e.g., identified by timestamp information 216). Accordingly, the variable portions 224, 234 include index information for identification of reference data that was received during a current period of time.

At block 640, the index generator 420 generates index information (e.g., the index information 122, 124, 132, 134) and updates the variable portion 224 of the count array 220 and the variable portion 234 of the inverted index array 230. Accordingly, at block 640, the index generator retrieves reference data values 214 and storage location information 212 for reference data that was received during a current time period to recompute the variable portions 224, 234 of the index 215.

In some examples, at block 640, the update may include re-computing the variable portion 224 of the count array 220 by generating a histogram of the reference data values and assigning count values to the corresponding reference data value based on the number of times the reference data value was received in a current time period. Further, the example index generator 420 assigns the retrieved storage location information to the updated count values (e.g., 8750, 8752 of the count array 120 of FIG. 1) in the variable portion 234 of the inverted index array 230 (e.g., (j), (k) of the inverted index array 130). In the illustrated example, at block 640, the update takes less time than updating the full index 215 (similar to the description in connection with FIG. 1) because only the variable portions 224, 234 of the index 215 are being updated, and thus fewer reference data values and storage location information are re-indexed.

Following the update at block 640 of FIG. 6, at block 650, the update controller 440 determines whether the reference index updater 340 is to continue monitoring the reference data array 210 (and/or reference database 314) for more updates. If the update controller 440 determines that monitoring is to end (e.g., in the event of a system failure, a system shutdown, or instructions to end monitoring from a user, processor, etc.), the instructions of FIG. 6 end. If the update controller 440 determines that monitoring is to continue, control returns to block 610.

Returning to block 610 of FIG. 6, in the event that the update controller 440 determines that a full system update is to occur (e.g., the timer 430 has indicated a time to perform a full update of the index 215), control advances to block 670. At block 670, the example update controller 440 instructs the index generator 420 to perform a full update of the index 215 and the index generator 420 clears the variable portions 224, 234 of the index 215.

An example of a full update of the reference data array 210 is shown in FIG. 7. In FIG. 7, the reference data array 210 is updated once per day (e.g., at 12:00 AM EST), though other rates (e.g., twice per day, once every 10 hours, etc.) may be implemented. In the illustrated example of FIG. 7, reference data corresponding to an oldest time period (e.g., DAY 9) is removed from the reference data array 210 (block 680 of FIG. 6). In the example of FIG. 7, the timestamp information 216 indicates when the reference data was received in the reference database reference data array 210. In some examples, the timestamp information corresponds to when media corresponding to the reference data was broadcasted.

Referring back to the example of FIG. 6, at block 680, the shifter 540 identifies reference data in the data array 210 associated with an oldest period of time based on the timestamp information 216. The example shifter 540 removes the reference data 710 (and corresponding reference data information, such as timestamp information) from the reference data array 210. For example, in FIG. 7, once per day, reference data corresponding to the 8^{th} day (DAY 8) prior to the current day is removed from the reference data array 210, shown as removed data 710. At the time of the update (e.g., 12:00 AM EST) in the example of FIG. 7, reference data corresponding to the current day shifts to become data corresponding to Day 1, data corresponding to Day 1 becomes data corresponding to Day 2, etc. As new reference data is received after the full update, the new data corresponds to the current day. In the illustrated example of FIG. 7, the reference data array 210 may be a dedicated database for reference data corresponding to live programming and/or programming that was broadcast live.

At block 690, the fixed portions 222, 232 of the count array 220 and inverted index array 230 are recomputed similar to the computation described with respect to FIG. 1. The fixed portions 222, 232 now include index information corresponding to reference data that previously was indexed in the variable portions 224, 234. As such, at block 690, at the time of the update (e.g., 12:00 AM EST), the fixed portions 222, 232 contain all index information for the updated reference data array 210 (which excludes the data 710) and the variable portions 224, 234 were cleared to allow for reference data corresponding to a new current time period (e.g., the day beginning at 12:00 AM EST). Accordingly, the index 215 is then fully updated and the fixed portions 222, 232 are referenced by the query matcher 350 when query data corresponding to a previous period of time (e.g., 8 days before 12:00 AM EST) is received. After block 690, control advances to block 620, where the index controller 440 determines whether reference data was recently received.

FIG. 8 is a block diagram of an example processor platform 800 capable of executing the instructions of FIG. 6 to implement the reference index updater 340 of FIGS. 3 and/or 4. The processor platform 800 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface. The interface circuit may be used to implement the example input/output 460 of FIG. 4.

In the illustrated example, one or more input devices 822 are connected to the interface circuit 820. The input device(s) 822 permit a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 600 of FIG. 6 may be stored in the mass storage device 828, in the volatile memory 814, in the non-volatile memory 816, and/or on a removable tangible computer readable storage medium such as a CD or DVD. One or more of the mass storage device 828, the volatile memory 814, the non-volatile memory 816, or a removable tangible computer readable medium may be used to implement the reference data database 314 of FIG. 3.

From the foregoing, it will appreciate that the above disclosed methods, apparatus and articles of manufacture provide an index using timestamps that includes a portion that is updated at a variable rate for reference data corresponding to a current time period and a portion that is updated at a fixed rate for reference data corresponding to a past time period. Such an index lowers latency and computing time of the updates.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to update a reference database index, the method comprising:
in response to receiving reference data at a reference database:
inserting the reference data in a first portion of the reference database, and
updating a first portion of an index corresponding to the first portion of the reference database; and
updating a second portion of the reference database, wherein updating the second portion of the reference database comprises:
shifting the reference data from the first portion of the reference database to the second portion of the reference database, and
after shifting, recomputing a second portion of an index corresponding to the second portion of the reference database.

2. A method according to claim 1, wherein updating the second portion of the reference database comprises removing an oldest portion of the reference database prior to the recomputing.

3. A method according to claim 1, wherein the first portion of the index comprises a variable count array and a variable inverted index array and the second portion of the index comprises a fixed count array and a fixed inverted index array.

4. A method according to claim 1, wherein recomputing the second portion of the index comprises clearing the first portion of the index.

5. A method according to claim 1, wherein the first portion of the index stores index information corresponding to reference data associated with a most recent period of time.

6. A method according to claim 1, wherein the second portion of the inverted index stores index information corresponding to reference data associated with a past period of time.

7. A method according to claim 6, wherein the past period of time comprises a number of calendar days before a current day.

8. A method according to claim 1, wherein updating the second portion of the reference database is performed at least one of periodically or according to a schedule.

9. A method according to claim 1, wherein the reference data comprises media identification data.

10. An apparatus to update a reference database index, the apparatus comprising:
a update controller to, in response to receiving reference data at a reference database, insert the reference data in a first portion of the reference data;
an index generator to update a first portion of an index corresponding to the first portion of the reference database; and
a shifter to update a second portion of the reference database by shifting the reference data from the first portion of the reference database to the second portion of the reference database, the index generator to recomputed a second portion of an index corresponding to the second portion of the reference database after the shift.

11. An apparatus according to claim 10, wherein the shifter is to remove an oldest portion of the reference database prior to the recomputing.

12. An apparatus according to claim 10, wherein the first portion of the index comprises a variable count array and a variable inverted index array, and the second portion of the index comprises a fixed count array and a fixed inverted index array.

13. An apparatus according to claim 10, wherein the shifter is to clear the first portion of the index.

14. An apparatus according to claim 10, wherein the first portion of the index is to store index information corresponding to reference data associated with a most recent time period.

15. An apparatus according to claim 10, wherein the second portion of the index is to store index information corresponding to reference data associated with a past period of time.

16. An apparatus according to claim 15, wherein the past period of time comprises a number of calendar days before a current day.

17. An apparatus according to claim 10, wherein the shifter is to update the second portion of the reference database at least one of periodically or according to a schedule

18. An apparatus according to claim 10, wherein the reference data comprises media identification data.

19. A tangible computer readable storage medium comprising instructions that, when executed, cause a machine to at least:
in response to receiving reference data at a reference database:
insert the reference data in a first portion of the reference database, and
update a first portion of an index corresponding to the first portion of the reference database; and
update a second portion of the reference database, wherein updating the second portion of the reference database comprises:
shift the reference data from the first portion of the reference database to the second portion of the reference database, and
recompute a second portion of an index corresponding to the second portion of the reference database after the shift.

20. A storage medium according to claim 19, wherein the instructions when executed further cause the machine to remove an oldest portion of the reference database prior to the recomputing.

21. A storage medium according to claim 19, wherein the first portion of the index comprises a variable count array and a variable inverted index array and the second portion of the index comprises a fixed count array and a fixed inverted index array.

22. A storage medium according to claim 19, wherein the instructions when executed further cause the machine to recompute the second portion of the index by clearing the first portion of the index.

23. A storage medium according to claim 19, wherein the first portion of the index is to store index information corresponding to reference data associated with a most recent period of time.

24. A storage medium according to claim 19, wherein the second portion of the inverted index is to store index information corresponding to reference data associated with a past period of time.

25. A storage medium according to claim 24, wherein the past period of time comprises a number of calendar days before a current day.

26. A storage medium according to claim 19, wherein the instructions when executed further cause the machine to update the second portion of the reference database at least one of periodically or according to a schedule.

27. A storage medium according to claim 19, wherein the reference data comprises media identification data.
